(19) United States
(12) Patent Application Publication
(10) Pub. No.: US 2009/0227675 A1
(43) Pub. Date: Sep. 10, 2009

(54) Antimicrobial Compositions

(76) Inventors: Susan Lindstrom, Ramsey, NJ (US); John J. Merianos, Bloomfield, NJ (US); Nancy Clements, North Plainfield, NJ (US)

Correspondence Address: INTERNATIONAL SPECIALTY PRODUCTS;WILLIAM J. DAVIS, ESQ., 1361 ALPS ROAD, WAYNE, NJ, 07470, US

(21) Appl. No.: 12/392,531

(22) Filed: Feb. 25, 2009

Related U.S. Application Data
(60) Provisional application No. 61/034,585, filed on Mar. 7, 2008.

(51) Int. Cl. A01N 37/06; A01P 1/00

(52) U.S. Cl. 514/547

(57) ABSTRACT

Antimicrobial compositions which are active against bacteria, yeast and mold spores are described. The compositions may be blends of (I) an acrylate/methacrylate copolymer having a hydrophobic network structure and (II) a preservative component comprising comprising (A) an isothiazolinone or (B)phenoxyethanol and either (i) a 1,2-diol or (ii) benzoic acid and dehydroacetic acid.

### FIELD OF THE INVENTION

The present invention relates to antimicrobial compositions, and more particularly, to antimicrobial compositions comprising a blend of a copolymer of acrylates/alkyl methacrylates having a network structure and a preservative component. Examples of useful preservative components include those containing (A) an isothiazolinone or (B) phenoxyethanol with either (i) a 1,2-diol or (ii) benzoic acid and dehydroacetic acid.

### BACKGROUND OF THE INVENTION

Personal care products come in many different forms. They include creams, lotions, pastes, liquids, aerosols, shampoos, gels, wipes, bars, sticks, powders and granules any or all of which are intended for topical application to the hair and/or skin including the scalp and the mucosa including the lips.

The products are generally designed to have a substantial shelf life. The products need to be manufactured at one site, transported possibly over a considerable distance to a depot or other storage facility prior to further transport to a point of sale. The product may then spend considerable time on a retailer's shelf prior to purchase and farther storage by the user whether for individual use or use in, for example, a hotel, workplace, institution or the like. All of such storage will take place under uncontrolled conditions including considerable variation in temperature.

In order to keep bacterial and fungal growth in such products at an acceptable level it is conventional practice for the products to contain a preservative. Many preservatives are available. The appropriate preservative has to be selected with regard to its efficacy and its acceptability to contact with human or animal skin. With regard to its acceptability there are in many countries laws and regulations governing the maximum permitted content of preservative in products intended for human use due to their possible toxic or otherwise harmful effect.

The need to control microbiological growth in personal care products is known to be particularly acute in water based products such as non-ionic oil-in-water emulsions and in pre-impregnated wipes such as baby wipes.

For example, U.S. Pat. No. 6,607,738 describes a preservative system of iodopropynyl butyl carbamate (IPBC) and phenoxyethanol (PE) in a weight ratio of 1:90 to 1:400 for use in personal care products.

U.S. Pat. No. 5,516,510 discloses deodorizing active ingredients to reduce the unpleasant odor caused by microorganisms which comprised glycerin monoalkyl ether in combination with an astringent and/or a naturally occurring deodorant.

EP 1206933 describes a preservative composition of caprylyl glycol (1,2-octanediol) and iodopropynyl butyl carbamate in a weight ratio of 0.1 to 500.

U.S. Pat. No. 5,733,362 discloses an anti-bacterial composition of 2-methyl-4,5-trimethylene-4-isothiazoline-3-on; 3-iodo-2-propynyl butyl carbamate and 2-phenoxyethanol.

EP 1238651 discloses that the activity of preservative mixtures of iodopropynyl butyl earbamate and phenoxyethanol, in a weight ratio of 1:90 to 1:200, preferably 1:100, can be potentiated by adding caprylyl glycol thereto, in a weight ratio of the latter to the mixture of 0.1 to 500, preferably 1:55. Thus, the formulation of caprylyl glycol, iodopropynyl butyl carbamate and phenoxyethanol had weight ratios of each of 55:1:100 to 200:1:400, respectively. The document discloses personal care formulations containing 0.1-30% caprylyl glycol, preferably 0.5%; with 0.001-1% IPBC, preferably 0.001-0.01%; and with phenoxyethanol of 0.1-3%, preferably 0.5-1%.

JP Application No.11045504 discloses an antiseptic microbicide and compositions thereof which contained a 1,2-alkane diol. These compositions effectively reduced the required dosage of conventional antiseptic microbicides such as paraben, benzoic acid and the like. The 1,2-alkane diol therein could be blended with a photosensitizer, benzoic acid or its salt, phenoxyethanol or 4-isopropyl-3-methylphenol. However, there was no disclosure of suitable blends of 1,2-alkane diol and phenoxyethanol at predetermined weight ratios and IILB values, which could deliver water insoluble biocides such as IPBC into aqueous personal care systems at a relatively high concentration of such biocides.

These and other prior art references in this field were concerned with the problem that many are antibacterial such as IPBC have limited aqueous solubility in personal care systems; particularly at the high concentrations necessary for effective antimicrobial activity. Thus, at very low concentrations they remain in solution but do not contribute as much activity as desired for these products.

Accordingly, it is desirable to provide an antimicrobial composition which is a blend of (I) a copolymer of acrylateslalkyl methacrylates having a network structure and (II) a mixture of phenoxyethanol and caprylyl glycol, at a predetermined weight ratio, which can deliver water-insoluble biocides into an aqueous personal care system at relatively high concentrations to provide effective preservative acting for such systems.

Alternatively, it is desirable to provide an antimicrobial composition which is a blend of (I) a copolymer of acrylates/alkyl methacrylates having a network structure and (II) a mixture of phenoxyethanol, benzoic acid and dehydroacetic acid.

In yet another aspect, it is desirable to provide an antimicrobial composition which is a blend of (I) a copolymer of acrylates/alkyl methacrylates having a network structure and (II) a preservative component containing a isothiazolinone, such as methylisothiazolinone.

### BRIEF SUMMARY OF THE INVENTION

The present invention relates to an antimicrobial composition which is active against bacteria, yeast and mold spores. In accordance with certain aspects of the invention, the composition contains of a blend of (I) a polymer having a hydrophobic network structure wherein the polymer is prepared from monomers selected from the group consisting of (meth)acrylic acid, C₁-C₅₀ alkyl(meth)acrylates, blends of C₁₀-C₅₀ alkyl(meth)acrylates, unsaturated vinyl esters of (meth-)acrylic acid derived from fatty acids and fatty alcohols and combinations thereof; and (II) a preservative component comprising (A) an isothiazolinone or (B) phenoxyethanol with either (i) a 1,2-diol selected from the group consisting of 1,2-pentane diol, 1,2-hexane diol, 1,2-octane diol, and combinations thereof or (ii) benzoic acid and dehydroacetic acid.

The invention also encompasses products, such as personal care products, which include the antimicrobial composition described above, preferably wherein the antimicrobial composition is present in an amount of about 0.1-2% by weight of the product, more particularly in an amount of about 0.5-1.5%.

### DETAILED DESCRIPTION OF THE INVENTION

The present invention relates to a synergistic blend of an acrylate copolymer and a preservative component. In accordance with certain embodiments, the paraben-free preservative component comprises phenoxyethanol and either (i) a 1,2-diol such as 1,2-pentane diol, 1,2-hexane diol, 1,2-octane diol, or combinations thereof or (ii) benzoic acid and dehydroacetic acid. In accordance with other embodiments of the invention, the preservative component comprises an isothiazolinone, such as methylisothiazolinone. In accordance with certain embodiments, the preservative component is paraben-free and/or formaldehyde-free.

The acrylate copolymers useful in the present invention include polymers capable of forming a network structure. Examples of useful polymers are described in U.S. Patent Application Publication No. 2003/0021847 to Baxter et al., the contents of which are incorporated herein by reference. In accordance with certain embodiments of the present invention, the polymer is prepared from monomers selected from the group consisting of (meth)acrylic acid, C₁-C₅₀ alkyl(meth)acrylates such as methyl(meth)acrylate, ethyl(meth)acrylate, isopropyl(meth)acrylate, butyl(meth)acrylate, 2-ethylhexyl acrylate, benzyl(meth)acrylate, octyl(meth)acrylate, decyl(meth)acrylate, lauryl acrylate, lauryl(meth)acrylate, oleyl(meth)acrylate, palmityl(meth)acrylate, stearyl(meth)acrylate, cetyl(meth)acrylate, and eicosyl(meth)acrylate, blends of C₁₀-C₅₀ alkyl(meth)acrylates such as cetyl-eicosyl(meth)acrylate, vinyl urethanes, aromatic and alkylaromatic esters of (meth)acrylic acid, unsaturated vinyl esters of (meth)acrylic acid derived from fatty acids and fatty alcohols and combinations thereof. In accordance with a particularly useful aspect of the invention, the polymer may be a tetrapolymer emulsion polymerization product of methacrylic acid, methyl methacrylate, butyl acrylate and cetyl-eicosyl methacrylate. A particularly useful tetrapolymer of this type is Allianz™ OPT (INCI name acrylates/C12-22 alkylmethacrylate copolymer) commercially available from ISP.

In accordance with one aspect of the present invention, the preservative mixture component of the composition comprises phenoxyethanol and either (i) a 1,2-diol such as 1,2-pentane diol, 1,2-hexane diol, 1,2-octane diol, or combinations thereof or (ii) benzoic acid and dehydroacetic acid.

Examples of blends containing a 1,2-diol and phenoxyethanol are described in U.S. Patent Application Publication No. 2005/00228032 to Merianos et al., the contents of which are incorporated herein by reference. In accordance with particular embodiments, the blend may contain from about (a) 40-60% of a 1,2-diol selected from the group consisting of 1,2-pentanediol, 1,2-hexanediol, 1,2-octanediol and mixtures thereof; (b) 40-60% of phenoxyethanol; and (c) 0-10% of a co-biocide selected from the group consisting of sorbic acid, benzoic acid, dibromodicyanobutane, iodopropynyl butyl carbamate and 1,2-benzisothiazolin-3-one, wherein the percentages are by weight based on the total weight of components (a) and (b). In accordance with certain embodiments, the preservative component comprises about 42-47 wt % 1,2-diol and about 53-58 wt % phenoxyethanol based on the total weight of phenoxyethanol and 1,2-diol.

In accordance with certain embodiments, the preservative component further includes (c) sorbic acid.

Most preferably, the preservative component includes (a) present in an amount of about 44% and (b) present in an amount of about 56%, and, optionally, (c) is sorbic acid, present in an amount of about 5-7.5% of the composition, wherein the percentages are by weight based on the total weight of components (a) and (b).

Examples of preservative components containing phenoxyethanol and a 1,2-diol such as 1,2-pentane diol, 1,2-hexane diol, 1,2-octane diol, or combinations thereof include, but are not limited to, OPTIPHEN® and OPTIPHEN® PLUS. OPTIPHEN® PLUS is a liquid preservative formulation containing a blend of phenoxyethanol, sorbic acid and 1,2-octane diol. Products from the OPTIPHEN® family of preservatives are available from ISP.

Alternatively, the preservative component may comprise a mixture of phenoxyethanol, benzoic acid and dehydroacetic acid. In accordance with particularly useful embodiments of the present invention, the mixture contains phenoxyethanol, benzoic acid and dehydroacetic acid in a weight ratio of about 80±1%, 12±0.5% and 8±0.3% respectively. An example of a preservative component in accordance with this aspect of the invention is OPTIPHIEN® ND available from ISP.

In accordance with other embodiments of the invention, the preservative component comprises an isothiazolinone, such as methylisothiazolinone. In accordance with particularly useful embodiments of the present invention, the preservative component contains methylisothiazolinone and water. An example of a preservative component in accordance with this aspect of the invention is OPTIPHEN® MIT available from ISP.

In accordance with particular embodiments of the present invention, from about 0.75 wt % to 1.5 wt % of the preservative component is included in the composition with the copolymer having a network structure based on the total weight of the polymer and preservative component. In certain embodiments, the copolymer is Allianz® OPT. In accordance with particularly useful aspects of the present invention, the polymer is present in a mixture of water and propylene glycol.

The preservative systems of the present invention are particularly useful in the formulation of personal care products, but may also be used in household products, industrial products, etc. Typically, the preservative system is present in an amount of about 0.01 to 30% by weight of the product, more particularly from about 0.1-2% by weight of the product, in certain cases, from about 0.5-1.5%.

The invention will now be described in more detail by the following challenge test examples on the invention formulations.

These data results show that a combination of (I) ALLIANZ™ and (II) OPTIPHEN® provide a unique and efficacious preservative system for all test organisms.

### PRESERVATIVE EFFICACY TEST

### EXAMPLE 1 (COMPARATIVE)

PRODUCT: Acrylates/C12-22 Alkylmethacrylate Copolymer dispersion in water and propylene glycol

PRESERVATIVE SYSTEM: Unpreserved

TABLE I

| TEST | | |
|---|---|---|
| ORGANISMS | INOCULUM (0 hours) | REINOCULUM (21 days) |
| Staph aureus | 2.4 × 10⁶ cfu/g of product | 7.4 × 10⁶ cfu/g of product |
| 6538 | | |
| E. coli 8739 | 5.4 × 10⁶ cfu/g of product | 4.9 × 10⁶ cfu/g of product |
| Pseudomonas | 3.1 × 10⁶ cfu/g of product | 5.1 × 10⁶ cfu/g of product |
| composite | | |
| C. albicans | 3.4 × 10⁵ cfu/g of product | 8.2 × 10⁵ cfu/g of product |
| 10231 | | |
| A. niger 16404 | 1.5 × 10⁵ cfu/g of product | 2.4 × 10⁵ cfu/g of product |

TABLE II

| | ASSAY INTERVALS | | | | |
|---|---|---|---|---|---|
| TEST ORGANISMS | 48 HRS | 7 D | 14 D | 21 D | 28 D |
| Staphylococcus aureus | 1.03E4 | >1E4 | 1.03E4 | 6.8E3 | >1E4 |
| Escherichia coli | >1E6 | >1E4 | 1.6E3 | 3.2E3 | >1E4 |
| Pseudomonas composite | 5.3E3 | 5E3 | 5.9E3 | 7.8E3 | >1E4 |
| Candida albicans | 1.7E4 | 8.1E3 | 1.5E2 | 3.1E2 | 1.7E3 |
| Aspergillus niger | 5E4 | >1E4 | >1E4 | >1E4 | >1E4 |

* Acrylates/C₁₂-C₂₂ alkylmethacrylate copolymer (in aqua/propylene glycol)

### PRESERVATIVE EFFICACY TEST

### EXAMPLE 2

PRODUCT: ACRYLATES/C12-22 ALKYLMETHACRYLATE COPOLYMER *

PRESERVATIVE SYSTEM: 0.75% OPTIPHEN®**

TABLE I

| TEST | | |
|---|---|---|
| ORGANISMS | INOCULUM (0 hours) | REINOCULUM (21 days) |
| Staph aureus | 2.4 × 10⁶ cfu/g of product | 7.4 × 10⁶ cfu/g of product |
| 6538 | | |
| E. coli 8739 | 5.4 × 10⁶ cfu/g of product | 4.9 × 10⁶ cfu/g of product |
| Pseudomonas | 3.1 × 10⁶ cfu/g of product | 5.1 × 10⁶ cfu/g of product |
| composite | | |
| C. albicans | 3.4 × 10⁵ cfu/g of product | 8.2 × 10⁵ cfu/g of product |
| 10231 | | |
| A. niger 16404 | 1.5 × 10⁵ cfu/g od product | 2.4 × 10⁵ cfu/g of product |

TABLE II

| | ASSAY INTERVALS | | | | |
|---|---|---|---|---|---|
| TEST ORGANISMS | 48 HRS | 7 D | 14 D | 21 D | 28 D |
| Staphylococcus aureus | <10 | <10 | <10 | <10 | <10 |
| Escherichia coli | 6.0 × 10¹ | <10 | <10 | <10 | <10 |
| Pseudomonas composite | <10 | <10 | <10 | <10 | <10 |
| Candida albicans | <10 | <10 | <10 | <10 | <10 |
| Aspergillus niger | 1.4 × 10³ | <10 | <10 | <10 | <10 |

* acrylates/C₁₂-C₂₂ alkylmethacrylate copolymer (in aqua/propylene glycol)
** phenoxyethanol (53-58%) and caprylyl glycol (42-47%)

### PRESERVATIVE EFFICACY TEST

### EXAMPLE 3 (COMPARATIVE)

PRODUCT: ALLIANZ™ dispersion in water and propylene glycol

PRESERVATIVE SYSTEM: 1% Sodium Methylparaben

TABLE I

| TEST | | |
|---|---|---|
| ORGANISMS | INOCULUM (0 hours) | REINOCULUM (21 days) |
| Staph aureus | 1.3 × 10⁶ cfu/g of product | 2.4 × 10⁶ cfu/g of product |
| 6538 | | |
| E. coli 8739 | 5.4 × 10⁶ cfu/g of product | 1.1 × 10⁷ cfu/g of product |
| Pseudomonas | 3.1 × 10⁶ cfu/g of product | 4.2 × 10⁶ cfu/g of product |
| composite | | |
| Fungal | 1.7 × 10⁶ cfu/g of product | 3.0 × 10⁶ cfu/g of product |
| composite | | |

TABLE II

| | ASSAY INTERVALS | | | | |
|---|---|---|---|---|---|
| TEST ORGANISMS | 48 HRS | 7 D | 14 D | 21 D | 28 D |
| Staphylococcus aureus | <10 | <10 | <10 | <10 | <10 |
| Escherichia coli | 5.6E5 | <10 | <10 | <10 | <10 |
| Pseudomonas composite | <10 | <10 | <10 | <10 | <10 |
| Fungal composite | 1.1E5 | 4E4 | 2.1E3 | 2E2 | 2E3 |

### PRESERVATIVE EFFICACY TEST

### EXAMPLE 4

PRODUCT: ACRYLATES/C12-22 ALKYLMETHACRYLATE COPOLYMER dispersion in water and propylene glycol

PRESERVATIVE SYSTEM: 1.2% OPTIPHEN® ND

TABLE I

| TEST | | |
|---|---|---|
| ORGANISMS | INOCULUM (0 hours) | REINOCULUM (21 days) |
| Staph aureus | 2.4 × 10⁶ cfu/g of product | 7.4 × 10⁶ cfu/g of product |
| 6538 | | |
| E. coli 8739 | 5.4 × 10⁶ cfu/g of product | 4.9 × 10⁶ cfu/g of product |
| Pseudomonas | 3.1 × 10⁶ cfu/g of product | 5.1 × 10⁶ cfu/g of product |
| composite | | |
| C. albicans | 3.4 × 10⁵ cfu/g of product | 8.2 × 10⁵ cfu/g of product |
| 10231 | | |
| A. niger 16404 | 1.5 × 10⁵ cfu/g od product | 2.4 × 10⁵ cfu/g of product |

TABLE II

| | ASSAY INTERVALS | | | | |
|---|---|---|---|---|---|
| TEST ORGANISMS | 48 HRS | 7 D | 14 D | 21 D | 28 D |
| Staphylococcus aureus | <10 | <10 | <10 | <10 | <10 |
| Escherichia coli | <10 | <10 | <10 | <10 | <10 |
| Pseudomonas composite | <10 | <10 | <10 | <10 | <10 |
| Candida albicans | <10 | <10 | <10 | <10 | <10 |
| Aspergillus niger | 1.4 × 10³ | <10 | <10 | <10 | <10 |

* phenoxyethanol (80 +/− 1%), benzoic acid (12 +/− 0.5%), and dehydroacetic acid (8 +/− 0.3%)

### PRESERVATIVE EFFICACY TEST

### EXAMPLE 5

PRODUCT: ACRYLATES/C12-22 ALKYLMETHACRYLATE COPOLYMER dispersion in water and propylene glycol

PRESERVATIVE SYSTEM: 1.5% OPTIPHEN®

TABLE I

| TEST | | |
|---|---|---|
| ORGANISMS | INOCULUM (0 hours) | REINOCULUM (21 days) |
| Staph aureus | 2.4 × 10⁶ cfu/g of product | 7.4 × 10⁶ cfu/g of product |
| 6538 | | |
| E. coli 8739 | 5.4 × 10⁶ cfu/g of product | 4.9 × 10⁶ cfu/g of product |
| Pseudomonas | 3.1 × 10⁶ cfu/g of product | 5.1 × 10⁶ cfu/g of product |
| composite | | |
| C. albicans | 3.4 × 10⁵ cfu/g of product | 8.2 × 10⁵ cfu/g of product |
| 10231 | | |
| A. niger 16404 | 1.5 × 10⁵ cfu/g od product | 2.4 × 10⁵ cfu/g of product |

TABLE II

| | ASSAY INTERVALS | | | | |
|---|---|---|---|---|---|
| TEST ORGANISMS | 48 HRS | 7 D | 14 D | 21 D | 28 D |
| Staphylococcus aureus | <10 | <10 | <10 | <10 | <10 |
| Escherichia coli | <10 | <10 | <10 | <10 | <10 |
| Pseudomonas composite | <10 | <10 | <10 | <10 | <10 |
| Candida albicans | <10 | <10 | <10 | <10 | <10 |
| Aspergillus niger | 1.2 × 10² | <10 | <10 | <10 | <10 |

### PRESERVATIVE EFFICACY TEST

### EXAMPLE 6

PRODUCT: ACRYLATES/C12-22 ALKYLMETHIACRYLATE COPOLYMER dispersion in water and propylene glycol

PRESERVATIVE, SYSTEM: 1.5% OPTIPHEN® Plus*

TABLE I

| TEST | | |
|---|---|---|
| ORGANISMS | INOCULUM (0 hours) | REINOCULUM (21 days) |
| Staph aureus | 2.4 × 10⁶ cfu/g of product | 7.4 × 10⁶ cfu/g of product |
| 6538 | | |
| E. coli 8739 | 5.4 × 10⁶ cfu/g of product | 4.9 × 10⁶ cfu/g of product |
| Pseudomonas | 3.1 × 10⁶ cfu/g of product | 5.1 × 10⁶ cfu/g of product |
| composite | | |
| C. albicans | 3.4 × 10⁵ cfu/g of product | 8.2 × 10⁵ cfu/g of product |
| 10231 | | |
| A. niger 16404 | 1.5 × 10⁵ cfu/g od product | 2.4 × 10⁵ cfu/g of product |

TABLE II

| | ASSAY INTERVALS | | | | |
|---|---|---|---|---|---|
| TEST ORGANISMS | 48 HRS | 7 D | 14 D | 21 D | 28 D |
| Staphylococcus aureus | <10 | <10 | <10 | <10 | <10 |
| Escherichia coli | <10 | <10 | <10 | <10 | <10 |
| Pseudomonas composite | <10 | <10 | <10 | <10 | <10 |
| Candida albicans | <10 | <10 | <10 | <10 | <10 |
| Aspergillus niger | 1.0 × 10¹ | <10 | <10 | <10 | <10 |

* phenoxyethanol (50.5-54.5%), caprylyl glycol (40-44%), and sorbic acid (5-7.5%)

### PRESERVATIVE EFFICACY TEST

### EXAMPLE 7

PRODUCT: ACRYLATES/C12-22 ALKYLMETHACRYLATE COPOLYMER dispersion in water and propylene glycol

PRESERVATIVE SYSTEM: 0.1% OPTIPHEN®MIT*

TABLE I

| TEST | | |
|---|---|---|
| ORGANISMS | INOCULUM (0 hours) | REINOCULUM |
| Staph. aureus | 5.4 × 10⁶ cfu/g of product | 3.9 × 10⁶ cfu/g of product |
| 6538 | | |
| E. coli 8739 | 7.4 × 10⁶ cfu/g of product | 4.7 × 10⁶ cfu/g of product |
| Pseudomonas | 4.0 × 10⁶ cfu/g of product | 3.8 × 10⁶ cfu/g of product |
| Composite | | |
| C. albicans | 1.6 × 10⁴ cfu/g of product | 2.1 × 10⁶ cfu/g of product |
| 10231 | | |
| A. niger 16404 | 1.0 × 10³ cfu/g of product | 2.0 × 10⁵ cfu/g of product |

TABLE II

| | ASSAY INTERVALS | | | | |
|---|---|---|---|---|---|
| TEST ORGANISMS | 48 HRS | 7 D | 14 D | 21 D | 28 D |
| Staphylococcus aureus | >10 | <10 | <10 | <10 | <10 |
| Escherichia coli | 8.3 × 10⁵ | <10 | <10 | <10 | <10 |
| Pseudomonas composite | <10 | <10 | <10 | <10 | <10 |
| Candida albicans | <10 | <10 | <10 | <10 | <10 |
| Aspergillus niger | 9 × 10³ | 1.1E3 | 4E2 | 4E2 | >1E4 |

* Water and methylisothiazolinone (9.9%)

What is claimed is:

1. An antimicrobial composition which is active against bacteria, yeast and mold spores consisting essentially of a blend of (I) a polymer having a hydrophobic network structure wherein said polymer is prepared from monomers selected from the group consisting of (meth)acrylic acid, C₁-C₅₀ alkyl(meth)acrylates, blends of C₁₀-C₅₀ alkyl(meth)acrylates, unsaturated vinyl esters of (meth-)acrylic acid derived from fatty acids and fatty alcohols and combinations thereof, and
(II) a preservative mixture comprising:
(A) an isothiazolinone or
(B) phenoxyethanol with at least one of:
(i) a 1,2-diol selected from the group consisting of 1,2-pentane diol, 1,2-hexane diol, 1,2-octane diol, and combinations thereof, and
(ii) benzoic acid and dehydroacetic acid.

2. An antimicrobial composition in accordance with claim 1 wherein
(I) comprises a tetrapolymer emulsion polymerization product of methacrylic acid, methyl methacrylate, butyl acrylate and cetyl-eicosyl methacrylate.

3. An antimicrobial composition in accordance with claim 1 wherein
(II) comprises a mixture of phenoxyethanol and 1,2-octane diol.

4. An antimicrobial composition in accordance with claim 3 wherein (II) comprises about 53-58 wt % phenoxyethanol and about 42-47 wt % 1,2-octane diol based on the total weight of phenoxyethanol and 1,2-octane diol.

5. An antimicrobial composition in accordance with claim 3 wherein (II) further comprises sorbic acid.

6. An antimicrobial composition in accordance with claim 5 wherein (II) comprises about 5-7.5 wt % sorbic acid based on the total weight of phenoxyethanol and 1,2-octane diol.

7. An antimicrobial composition in accordance with claim 1 wherein (I) is present as a liquid mixture of water and propylene glycol.

8. An antimicrobial composition in accordance with claim 1 wherein (II) comprises phenoxyethanol, benzoic acid and dehydroacetic acid.

9. An antimicrobial composition in accordance with claim 8 wherein (II) comprises about 79-81 wt % phenoxyethanol, about 11.5-12.5 wt % benzoic acid and about 7.7-8.3 wt % dehydroacetic acid based on the total weight of (II).

10. An antimicrobial composition in accordance with claim 1 wherein the preservative component is present in an amount of from about 0.75 wt % to 1.5 wt % based on the total weight of the composition.

11. An antimicrobial composition in accordance with claim 1 wherein.
(I) comprises a tetrapolymer emulsion polymerization product of methacrylic acid, methyl methacrylate, butyl acrylate and cetyl-eicosyl methacrylate; and
(II) comprises a mixture of phenoxyethanol and 1,2-octane diol.

12. An antimicrobial composition in accordance with claim 11 wherein (II) further comprises sorbic acid.

13. An antimicrobial composition in accordance with claim 11 wherein (II) comprises about 53-58 wt % phenoxyethanol and about 42-47 wt % 1,2-octane diol based on the total weight of phenoxyethanol and 1,2-octane diol.

14. An antimicrobial composition in accordance with claim 13 wherein (II) further comprises about 5-7.5 wt % sorbic acid based on the total weight of phenoxyethanol and 1,2-octane diol.

15. An antimicrobial composition in accordance with claim 1 wherein
(II) comprises methylisothiazolinone

16. An antimicrobial composition in accordance with claim 15 wherein
(II) comprises water and methylisothiazolinone.

17. An antimicrobial composition in accordance with claim 16 wherein:
(I) comprises a tetrapolymer emulsion polymerization product of methacrylic acid, methyl methacrylate, butyl acrylate and cetyl-eicosyl methacrylate.
